(19) United States
(12) Patent Application Publication
(10) Pub. No.: US 2026/0342764 A1
(43) Pub. Date: Oct. 29, 2026

(54) PERSONAL ELECTRONIC DEVICE FOR SELECTIVELY DISPLAYING NOTIFICATIONS FROM MOBILE APPLICATIONS ON A PERSONAL ELECTRONIC DEVICE AND A METHOD THEREFOR

(71) Applicant: Love Pangle, Elizabethtown, KY (US)

(72) Inventor: Love Pangle, Elizabethtown, KY (US)

(21) Appl. No.: 19/190,218

(22) Filed: Apr. 25, 2025

(51) Int. Cl. H04L 51/224; G01S 19/13; G06F 1/16; G06V 40/13

(52) U.S. Cl. CPC H04L 51/224; G01S 19/13; G06F 1/163; G06F 1/1686; G06F 1/1698; G06V 40/13

(57) ABSTRACT

A personal electronic device includes a housing, a display, a processor, and a non-transitory computer-readable recording medium. The non-transitory recording medium is designed to retrieve notifications from a plurality of mobile applications stored on the non-transitory computer-readable recording medium and operable by the processor, then filter the notifications into personal communication notifications 56 and all other notifications, wherein the personal communication notifications 56 relate to instant messages or direct messages transmitted via a messaging portion of a social media application, instant messages or direct messages transmitted via a messaging portion of a business application or interpersonal application, instant messages or direct messages transmitted via a messaging application, and email messages transmitted via an email application, and then only display the personal communication notifications 56.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to personal electronic devices such as smartphones and smartwatches and more particularly pertains to a new personal electronic device for selectively displaying notifications from mobile applications on the personal electronic device. Specifically, the personal electronic device is designed to filter out and display only notifications relating to personal communications, such as instant messages, direct messages, or email messages of other mobile applications, rather than all notifications from all mobile applications, such as status updates, shared videos and pictures, and email spam.

### (2) DESCRIPTION OF RELATED ART INCLUDING INFORMATION DISCLOSED UNDER 37 CFR 1.97 AND 1.98

The prior art relates to personal electronic devices such as smartphones and smartwatches. The prior art, as best understood, does not disclose a personal electronic device that is designed to filter out and display only notifications relating to personal communications, such as instant messages, direct messages, or email messages of other mobile applications, rather than all notifications from all mobile applications, such as status updates, shared videos and pictures, and email spam.

### (h) BRIEF SUMMARY OF THE INVENTION

An embodiment of the disclosure meets the needs presented above in a personal electronic device generally comprising a housing, a display, a processor, and a non-transitory computer-readable recording medium. The housing has a front wall, a rear wall, and a perimeter wall. The display is positioned in the front wall. The display is designed to display information and images. The processor is positioned in the housing. The processor is connected to the display. The non-transitory computer-readable recording medium is disposed in the housing and connected to the processor. The non-transitory computer-readable recording medium stores one or more programs which when executed by the processor cause the non-transitory recording medium to perform steps including: retrieving notifications from a plurality of mobile applications stored on the non-transitory computer-readable recording medium and operable by the processor; filtering the notifications into personal communication notifications and all other notifications, wherein personal communication notifications relate to instant messages or direct messages transmitted via a messaging portion of a social media application, instant messages or direct messages transmitted via a messaging portion of a business application or interpersonal application, instant messages or direct messages transmitted via a messaging application, and email messages transmitted via an email application; and displaying on the visual display only the personal communication notifications.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a personal electronic device according to an embodiment of the disclosure.

FIG. 2 is a front view of an embodiment of the disclosure.

FIG. 3 is a front view of an embodiment of the disclosure.

FIG. 4 is a back view of an embodiment of the disclosure.

FIG. 5 is a back view of an embodiment of the disclosure.

FIG. 6 is a block diagram of an embodiment of the disclosure.

### (j) DETAILED DESCRIPTION OF THE INVENTION

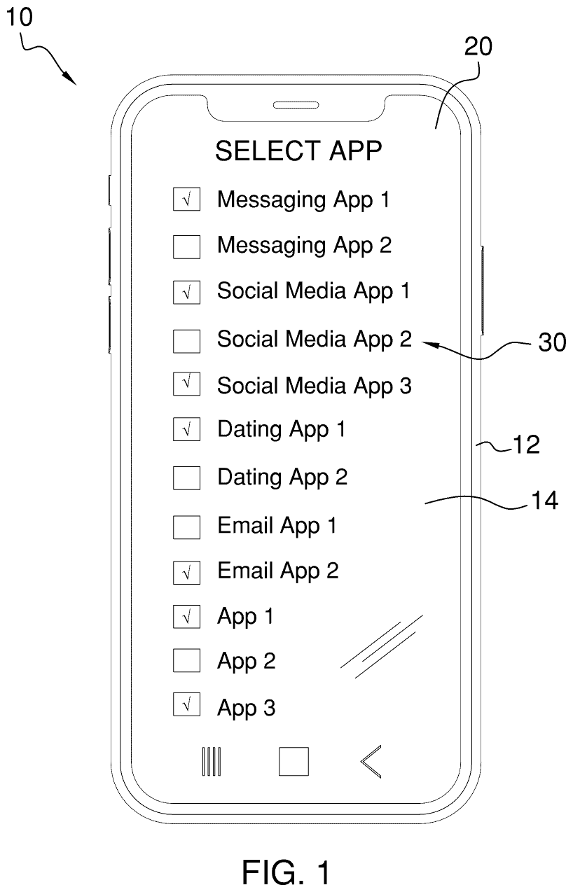

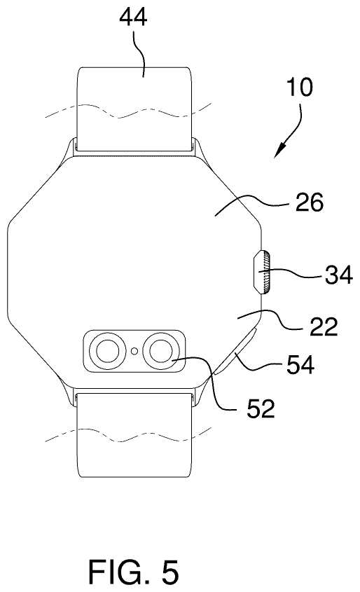

With reference now to the drawings, and in particular to FIGS. 1 through 6 thereof, a new personal electronic device embodying the principles and concepts of an embodiment of the disclosure and generally designated by the reference numeral 10 will be described.

It should be understood that the phrase “personal communication notification” as used herein refers to a notification that refers to or relates to any type of message directed at a specific user. Such messages can include direct messages, instant messages, text messages, and email messages, as well as any other directed communication that includes a personalized message. Such notifications do not include general notifications or reminders, such as, but not limited to, a status update on social media, shared photos or videos, group chats, spam email, or news articles.

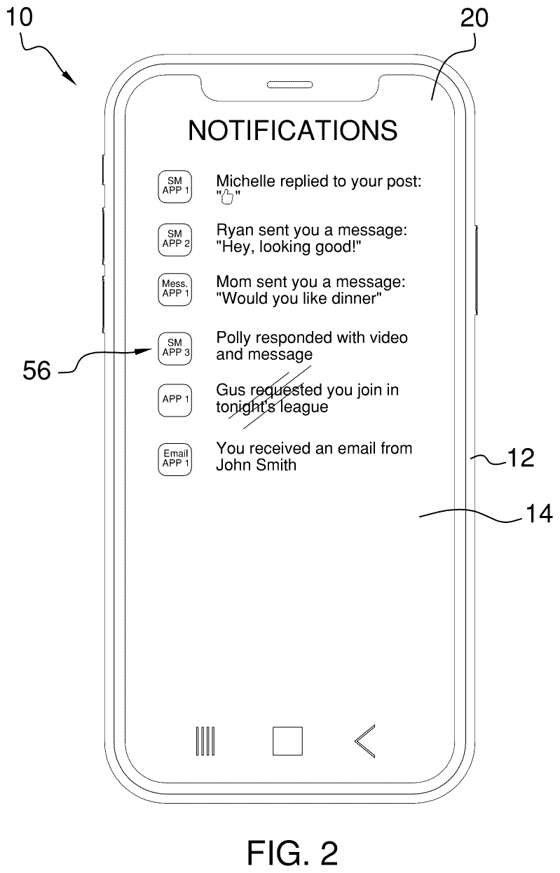

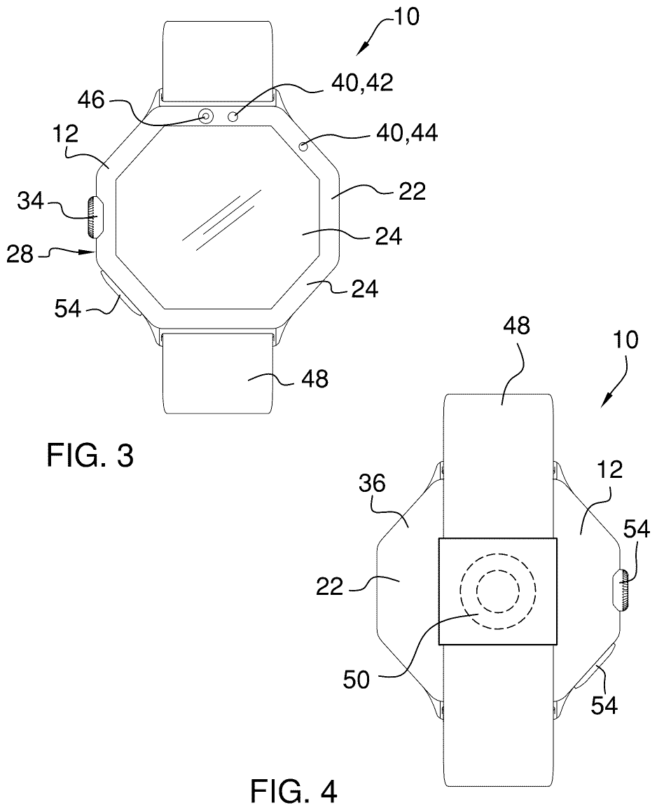

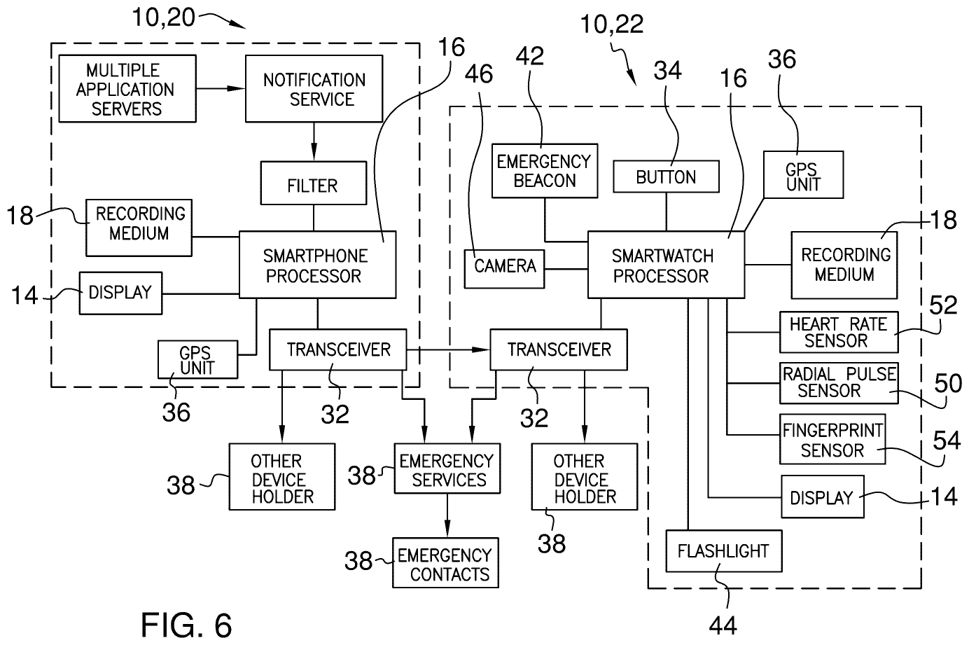

As best illustrated in FIGS. 1 through 6, the personal electronic device 10 generally comprises a housing 12, a display 14, a processor 16, and a non-transitory computer-readable recording medium 18. The personal electronic device 10 could be, for example, either a smartphone 20, such shown in FIGS. 1 and 2, or a smartwatch 22, as shown in FIGS. 3 through 5, or other handheld computing device, such as a tablet computer or personal data assistant. Components common to each type of device utilize the same numbering, even though they may have different designs or appearances. The relationship of one or more components is shown in the block diagram in FIG. 6. The housing 12 has a front wall 24, a rear wall 26, and a perimeter wall 28. The display 14 is positioned in the front wall 24. The display 14 is designed to display 14 information and images. The display 14 may be a touchscreen as is commonly used in personal electronic devices 10. The processor 16 is positioned in the housing 12. The processor 16 is connected to the display 14. The non-transitory computer-readable recording medium 18 is disposed in the housing 12 and connected to the processor 16. The non-transitory computer-readable recording medium 18 stores one or more programs which when executed by the processor 16 cause the non-transitory recording medium to perform steps including: retrieving notifications from a plurality of mobile applications stored on the non-transitory computer-readable recording medium 18 and operable by the processor 16; filtering the notifications into personal communication notifications 56 and all other notifications, wherein personal communication notifications 56 relate to instant messages or direct messages transmitted via a messaging portion of a social media application, instant messages or direct messages transmitted via a messaging portion of a business application or interpersonal application, instant messages or direct messages transmitted via a messaging application, and email messages transmitted via an email application; and displaying on the visual display 14 only the personal communication notifications 56.

The non-transitory computer-readable recording medium 18 stores one or more programs which when executed by the processor 16 cause the non-transitory recording medium to perform steps further including: displaying a list of mobile applications 30, also commonly referred to as apps, designed to provide the personal communication notifications 56 and retrieving the notifications only from selected ones of the list of the mobile applications 30.

In the exemplary embodiment, the personal electronic device 10 further includes a transceiver 32. The transceiver 32 is positioned in the housing 12. The transceiver 32 is coupled to the processor 16. The transceiver 32 is wirelessly connectable to a wireless network for transmission of data. A button 34 is coupled to the perimeter wall 28 of the housing 12. The button 34 is pressable for powering at least one of the display 14 and the processor 16 on and off. The button 34 is rotatable to activate the processor 16 to send an alert signal via the transceiver 32 to an external electronic device 38 indicating an emergency situation has occurred or is occurring. The external electronic device 38, as shown in FIG. 6, could be related to emergency services and personnel, emergency contacts, and other device holders, such as friends and family members.

In the exemplary embodiment, the personal electronic device 10 further includes a GPS unit 36. The GPS unit 36 is positioned in the housing 12. The GPS unit 36 is connected to the processor 16 to provide location data. The processor 16 is designed to transmit the location data via the transceiver 32 to the external electronic device 38 when the button 34 is rotated. As shown in FIG. 6, the location data can be sent to the external electronic devices 38 of emergency services and personnel, emergency contacts, and other device holders, such as friends and family members.

In the exemplary embodiment, the personal electronic device 10 further includes at least one lighting unit 40. The at least one lighting unit 40 is mounted in the front wall 24 or perimeter wall 28 of the housing 12. The at least one lighting unit 40 is designed to flash light intermittently or emit light continuously. In the exemplary embodiment in FIG. 3, the at least one lighting unit 40 includes an emergency beacon 42 which automatically activates and flashes when the button 34 is rotated, as well as a flashlight 44 that can be turned on or off voluntarily.

In the exemplary embodiment, the personal electronic device 10 further includes a camera 46. The camera 46 is mounted in the front wall 24 of the housing 12. The camera 46 is connected to the processor 16 for recording of pictures and video. Such information can be shown on the display 14, stored in the computer-readable recording medium, and/or transmitted to others.

In the exemplary embodiment in FIGS. 3 through 5, the personal electronic device 10 further includes a wristband 48. The wristband 48 is coupled to the housing 12 such that the housing 12 is wearable in the form of a smartwatch 22. The housing 12 is less than two inches in diameter. In the case of the personal electronic device 10 being a smartphone 20 as shown in FIGS. 1 and 2, the housing 12 is larger than two inches in height.

In the exemplary embodiment in FIGS. 3 through 5, the personal electronic device 10 further includes a radial pulse sensor 50. The radial pulse sensor 50 is coupled to the wristband 48. The radial pulse sensor 50 is designed to measure oxygen levels and heart rate. Such information can be shown on the display 14, stored in the computer-readable recording medium, and/or transmitted to others, such as automatically when the button 34 is rotated in an emergency situation, or possibly automatically when information indicating a dangerous health condition is detected.

In the exemplary embodiment in FIGS. 3 through 5, the personal electronic device 10 further includes a heart rate sensor 52. The heart rate sensor 52 is mounted in the rear wall 26. The heart rate sensor 52 is designed to detect irregular heart rates signaling at least one of: heart attack, myocardial infarction, tachycardia, brachycardia, irregular sinus rhythm, and stroke. Such information can be shown on the display 14, stored in the computer-readable recording medium, and/or transmitted to others, such as automatically when the button 34 is rotated in an emergency situation, or possibly automatically when information indicating a dangerous health condition is detected.

In the exemplary embodiment in FIGS. 3 through 5, the personal electronic device 10 further includes a fingerprint sensor 54. The fingerprint sensor 54 is mounted on the perimeter wall 28 of the housing 12. The fingerprint sensor 54 is designed to detect a fingerprint required to activate at least one of the processor 16 and the display 14.

The personal electronic device 10, specifically the smartphone 20 shown in FIGS. 1 and 2 and represented schematically in FIG. 6, is designed to selectively display 14 notifications from mobile applications on the personal electronic device 10. In one possible embodiment, this function is also usable on the smartwatch 22. Notifications are retrieved from a plurality of mobile applications stored on the non-transitory computer-readable recording medium 18 of the personal electronic device 10 and operable by the processor 16 of the personal electronic device 10. As shown in FIG. 6, multiple application servers provide the notifications from various services, such as, but not limited to, social media, text messaging, and dating, travel, and shopping applications, to the notification service on the personal electronic device 10. The processor 16 then filters the notifications into personal communication notifications 56 and all other notifications, wherein personal communication notifications 56 relate to instant messages or direct messages transmitted via a messaging portion of a social media application, instant messages or direct messages transmitted via a messaging portion of a business application or interpersonal application, instant messages or direct messages transmitted via a messaging application, and email messages transmitted via an email application. The processor 16 then displays on the visual display 14 of the personal electronic device 10 only the personal communication notifications 56. In this manner the user only views what the user considers to be important or time-sensitive communications that likely require immediate viewing and/or a response, as shown in FIG. 2. As shown in FIG. 1, the processor 16 can display 14 a list of the mobile applications 30 designed to provide the personal communication notifications 56, which the user can select or deselect to be part of the displayed list in FIG. 2. The processor 16 then retrieves the notifications only from selected ones of the list of the mobile applications 30.

Generally, a computing device in accordance with at least one possible embodiment of the present invention will also include one or more data storage devices, or be operatively connected to such storage devices, or both. However, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media, such as, for example, light pulses passing through a fiber-optic cable, or electrical signals transmitted through a wire.

In some embodiments, the steps and actions of the application instructions described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to a processor such that the processor can read information from, and write information to, the storage medium. In the alternative, the storage medium may be integrated into a processor. Further, in some embodiments, the processor and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product. Those skilled in the art would understand that each block of any flowchart illustrations and/or block diagrams in the figures, and combinations of blocks in any flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in any flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function or functions. In some embodiments, the functions noted in the blocks can occur out of the order noted in the Figures. For example, two or more blocks shown in succession could be executed concurrently, substantially or essentially concurrently, or in reverse order, depending upon the functionality involved. In some embodiments, each block of the block diagrams and/or flowchart illustrations, and combinations of blocks in the block diagrams and/or flowchart illustrations, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include, for example, routines, programs, components, and data structures that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices, such as personal data assistants, tablet or notebook computers, and mobile phones or smartphones, microprocessor-based or programmable consumer or industrial electronics, and other computer systems and devices. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets, such as, for example, data from one component interacting with another component in a local system, distributed system, and/or across a network such as the Internet with other systems via the signal. As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, such as, for example, within a cloud computing system.

Processors suitable for the execution of computer readable program instructions include both general and special purpose microprocessors and any one or more processors of any digital computing device. For example, each processor may be a single processing unit or a number of processing units and may include single or multiple computing units or multiple processing cores. The processor or processors can be implemented as one or more microprocessors, microcomputers, microcontrollers, digital signal processors, central processing units, state machines, logic circuitries, and/or any devices that manipulate signals based on operational instructions. For example, the processor or processors may be one or more hardware processors and/or logic circuits of any suitable type specifically programmed or configured to execute the algorithms and processes described herein. The processor or processors can be configured to retrieve and execute computer readable program instructions stored in the computer-readable media, which can program the processor or processors to perform the functions described herein.

In this disclosure, the term “processor” or “microprocessor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (A SIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the system can also be implemented in cloud computing environments. In this context, “cloud computing” refers to a model for enabling ubiquitous, convenient, on-demand network access to a shared pool of configurable computing resources, such as, for example, networks, servers, storage, applications, and services, that can be rapidly provisioned via virtualization and released with minimal management effort or service provider interaction and then scaled accordingly. A cloud model can be composed of various characteristics, such as, for example, on-demand self-service, broad network access, resource pooling, rapid elasticity, and measured service, service models, such as, for example, Software as a Service (“SaaS”) and Platform as a Service (“PaaS”), Infrastructure as a Service (“IaaS”), and deployment models such as, for example, private cloud, community cloud, public cloud, and hybrid cloud.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal electronic device comprising:
a housing, the housing having a front wall, a rear wall, and a perimeter wall;
a display, the display being positioned in the front wall, the display being configured to display information and images;
a processor, the processor being positioned in the housing, the processor being connected to the display; and
a non-transitory computer-readable recording medium, the non-transitory computer-readable recording medium being disposed in the housing and connected to the processor, the non-transitory computer-readable recording medium storing one or more programs which when executed by the processor cause the non-transitory recording medium to perform steps comprising:
retrieving notifications from a plurality of mobile applications stored on the non-transitory computer-readable recording medium and operable by the processor;
filtering the notifications into personal communication notifications 56 and all other notifications, wherein personal communication notifications 56 relate to instant messages or direct messages transmitted via a messaging portion of a social media application, instant messages or direct messages transmitted via a messaging portion of a business application or interpersonal application, instant messages or direct messages transmitted via a messaging application, and email messages transmitted via an email application; and
displaying on the visual display only the personal communication notifications 56.

2. The personal electronic device of claim 1, wherein the non-transitory computer-readable recording medium stores one or more programs which when executed by the processor cause the non-transitory recording medium to perform steps further comprising:
displaying a list of mobile applications configured to provide the personal communication notifications 56; and
retrieving the notifications only from selected ones of the list of the mobile applications.

3. The personal electronic device of claim 1, further comprising:
a transceiver, the transceiver being positioned in the housing, the transceiver being coupled to the processor, the transceiver being wirelessly connectable to a wireless network for transmission of data; and
a button, the button being coupled to the perimeter wall of the housing, the button being pressable for powering at least one of the display and the processor on and off, the button being rotatable to activate the processor to send an alert signal via the transceiver to an external electronic device indicating an emergency situation has occurred or is occurring.

4. The personal electronic device of claim 1, further comprising a GPS unit, the GPS unit being positioned in the housing, the GPS unit being connected to the processor to provide location data, the processor being configured to transmit the location data via the transceiver to the external electronic device when the button is rotated.

5. The personal electronic device of claim 1, further comprising at least one lighting unit, the at least one lighting unit being mounted in the front wall or perimeter wall of the housing, the at least one lighting unit being configured to flash light intermittently or emit light continuously.

6. The personal electronic device of claim 1, further comprising a camera, the camera being mounted in the front wall of the housing, the camera being connected to the processor for recording of pictures and video.

7. The personal electronic device of claim 1, further comprising a wristband, the wristband being coupled to the housing such that the housing is wearable in the form of a smartwatch, the housing being less than two inches in diameter.

8. The personal electronic device of claim 7, further comprising a radial pulse sensor, the radial pulse sensor being coupled to the wristband, the radial pulse sensor being configured to measure oxygen levels and heart rate.

9. The personal electronic device of claim 7, further comprising a heart rate sensor, the heart rate sensor being mounted in the rear wall, the heart rate sensor being configured to detect irregular heart rates signaling at least one of: heart attack, myocardial infarction, tachycardia, brachycardia, irregular sinus rhythm, and stroke.

10. The personal electronic device of claim 7, further comprising a fingerprint sensor, the fingerprint sensor being mounted on the perimeter wall of the housing, the fingerprint sensor being configured to detect a fingerprint required to activate at least one of the processor and the display.

11. The personal electronic device of claim 2, further comprising:
a transceiver, the transceiver being positioned in the housing, the transceiver being coupled to the processor, the transceiver being wirelessly connectable to a wireless network for transmission of data; and
a button, the button being coupled to the perimeter wall of the housing, the button being pressable for powering at least one of the display and the processor on and off, the button being rotatable to activate the processor to send an alert signal via the transceiver to an external electronic device indicating an emergency situation has occurred or is occurring.

12. The personal electronic device of claim 11, further comprising a GPS unit, the GPS unit being positioned in the housing, the GPS unit being connected to the processor to provide location data, the processor being configured to transmit the location data via the transceiver to the external electronic device when the button is rotated.

13. The personal electronic device of claim 12, further comprising at least one lighting unit, the at least one lighting unit being mounted in the front wall or perimeter wall of the housing, the at least one lighting unit being configured to flash light intermittently or emit light continuously.

14. The personal electronic device of claim 13, further comprising a camera, the camera being mounted in the front wall of the housing, the camera being connected to the processor for recording of pictures and video.

15. The personal electronic device of claim 14, further comprising a wristband, the wristband being coupled to the housing such that the housing is wearable in the form of a smartwatch, the housing being less than two inches in diameter.

16. The personal electronic device of claim 15, further comprising a radial pulse sensor, the radial pulse sensor being coupled to the wristband, the radial pulse sensor being configured to measure oxygen levels and heart rate.

17. The personal electronic device of claim 16, further comprising a heart rate sensor, the heart rate sensor being mounted in the rear wall, the heart rate sensor being configured to detect irregular heart rates signaling at least one of: heart attack, myocardial infarction, tachycardia, brachycardia, irregular sinus rhythm, and stroke.

18. The personal electronic device of claim 17, further comprising a fingerprint sensor, the fingerprint sensor being mounted on the perimeter wall of the housing, the fingerprint sensor being configured to detect a fingerprint required to activate at least one of the processor and the display.

19. A method of selectively displaying notifications from mobile applications on a personal electronic device, the method comprising the steps of:
retrieving notifications from a plurality of mobile applications stored on a non-transitory computer-readable recording medium of a personal electronic device and operable by a processor of the personal electronic device;
filtering the notifications into personal communication notifications 56 and all other notifications, wherein personal communication notifications 56 relate to instant messages or direct messages transmitted via a messaging portion of a social media application, instant messages or direct messages transmitted via a messaging portion of a business application or interpersonal application, instant messages or direct messages transmitted via a messaging application, and email messages transmitted via an email application; and
displaying on a visual display of the personal electronic device only the personal communication notifications 56.

20. The method of claim 19, further comprising the steps of:
displaying a list of mobile applications configured to provide the personal communication notifications 56; and
retrieving the notifications only from selected ones of the list of the mobile applications.
